(19) United States
(12) Patent Application Publication
(10) Pub. No.: US 2024/0342924 A1
(43) Pub. Date: Oct. 17, 2024

(54) ROBOT HAND HAVING HIGH DEGREE OF FREEDOM

(71) Applicant: Industry-University Cooperation Foundation Hanyang University Erica Campus, Ansan-si (KR)

(72) Inventors: Woo Seok RYU, Seoul (KR); Byung Ju YI, Siheung-si (KR); Ji Yeong LEE, Seoul (KR); Sung On LEE, Seongnam-si (KR)

(21) Appl. No.: 18/754,176

(22) Filed: Jun. 26, 2024

Related U.S. Application Data
(63) Continuation of application No. PCT/KR2022/021455, filed on Dec. 28, 2022.

(30) Foreign Application Priority Data
Dec. 29, 2021 (KR) 10-2021-0191064

(51) Int. Cl. B25J 15/00; B25J 9/10; B25J 9/12; B25J 17/00

(52) U.S. Cl. CPC B25J 15/0009; B25J 9/102; B25J 9/104; B25J 9/12; B25J 17/00

(57) ABSTRACT

Provided is a robot hand having a high degree of freedom comprising: a palm module; a first finger module comprising a first base frame detachably coupled to the palm module and at least two first finger portions connected to the first base frame and including multiple first joints; a second finger module comprising a second base frame detachably coupled to another side of the palm module and a second finger portion connected to the second base frame and including multiple second joints; a wire driving portion mounted inside the palm module and including a driving module for operating the first finger portions and the second finger portion, the driving module providing driving power to wires connected to the multiple first and second joints; and a gear driving portion for providing driving power to gears individually connected to the first finger portions and the second finger portion for performing abduction/adduction operations.

### TECHNICAL FIELD

The present invention relates to a robot hand having a high degree of freedom, and more specifically, to a robot hand having a high degree of freedom, capable of performing a precise and detailed movement.

### BACKGROUND ART

In a case of a tendon-driven robot hand, during design, the robot hand may be created to have the most compact size. However, a motor and a controller part for driving each tendon are larger than a hand for actual driving.

According to a conventional tendon-driven robot hand, a motor and a controller are usually mounted on a forearm to support driving of the robot hand. However, such a structure is difficult to be applied to an actual use space by a user.

Accordingly, there is a demand for development of a tendon-driven robot hand having improved practicality.

### DISCLOSURE

### Technical Problem

One technical object of the present invention is to provide a robot hand having a high degree of freedom, capable of performing a precise and detailed movement.

Another technical object of the present invention is to provide a robot hand having a high degree of freedom, capable of maximizing user convenience.

Technical objects of the present invention are not limited to the technical objects described above.

### Technical Solution

To achieve the objects described above, the present invention provides a robot hand having a high degree of freedom.

According to one embodiment, the robot hand having the high degree of freedom includes: a palm module having a set volume; a first finger module including a first base frame detachably coupled to one side of the palm module, and at least two first finger portions connected to the first base frame in one direction and including a plurality of first segments; a second finger module including a second base frame detachably coupled to an opposite side of the palm module, and a second finger portion connected to the second base frame and including a plurality of second segments; and a driving module mounted inside the palm module, and configured to operate the at least two first finger portions and the second finger portion, wherein the driving module includes: a wire driving portion configured to provide a driving force to wires that are individually connected to the first segments and the second segments, respectively; and a gear driving portion configured to provide a driving force to gears that are individually connected to the at least two first finger portions and the second finger portion so as to enable abduction/adduction (A/A) operations of the at least two first finger portions and the second finger portion.

According to one embodiment, each of connection between the first finger portion and the first base frame and connection between the second finger portion and the second base frame may be performed through a metacarpal (MCP) joint, each of connection between the first segments adjacent to each other and connection between the second segments adjacent to each other may be performed in a lengthwise direction through a proximal phalanx (PIP) joint and a distal phalanx (DIP) joint, and the MCP joint may provide 2 degrees of freedom, and each of the PIP joint and the DIP joint may provide 1 degree of freedom.

According to one embodiment, the first segment may include a first-first segment connected to the first base frame through the MCP joint, a first-second segment connected to the first-first segment through the PIP joint, and a first-third segment connected to the first-second segment through the DIP joint, and the first finger module may further include a first-first wire and a first-second wire connected to the first-first segment to bend/unfold the first-first segment about the MCP joint, a first-third wire and a first-fourth wire connected to the first-second segment to bend/unfold the first-second segment about the PIP joint, and a first-fifth wire and a first-sixth wire connected to the first-third segment to bend/unfold the first-third segment about the DIP joint.

According to one embodiment, the wire driving portion may include a first motor configured to provide a driving force to adjust tension of the first-first wire and the first-second wire, a second motor configured to provide a driving force to adjust tension of the first-third wire and the first-fourth wire, and a third motor configured to provide a driving force to adjust tension of the first-fifth wire and the first-sixth wire, the first to third motors may constitute one motor set connected to one of the first finger portions, and, when a plurality of first finger portions are provided, the wire driving portion may include a plurality of motor sets that are in one-to-one correspondence with the first finger portions.

According to one embodiment, the first finger module may further include a first bearing array, and the first bearing array may be configured to provide movement paths of the first-first wire and the first-second wire from the first motor to the first-first segment, provide movement paths of the first-third wire and the first-fourth wire from the second motor to the first-second segment, and provide movement paths of the first-fifth wire and the first-sixth wire from the third motor to the first-third segment.

According to one embodiment, the first-first wire and the first-second wire may be fixed to both widthwise sides of the first-first segment, the first-third wire, the first-fourth wire, the first-fifth wire, and the first-sixth wire may pass between the first-first wire and the first-second wire, the first-third wire and the first-fourth wire may be fixed to both widthwise sides of the first-second segment, and the first-fifth wire and the first-sixth wire may pass between the first-third wire and the first-fourth wire so as to be fixed to both widthwise sides of the first-third segment.

According to one embodiment, the first base frame may include a plurality of motor connection ports through which rotation shafts of the first to third motors are coupled, respectively, each of the motor connection ports may include a stopper member configured to restrict a rotation range of each of the rotation shafts, and the stopper member may include: a rotation member axially coupled to the rotation shaft, and including a protrusion protruding in a radial direction on one circumferential side of the rotation member; and a stopper facing both sides of a rotation path of the protrusion, and configured to restrain further rotation of the protrusion when the protrusion collides with the stopper while rotating.

According to one embodiment, the gear driving portion may include a fourth motor, and the first base frame may include a bevel gear connected to the first finger portion and the fourth motor, and configured to transmit a driving force provided from the fourth motor to the first finger portion.

According to one embodiment, the second segment may include a second-first segment connected to the second base frame through the MCP joint, a second-second segment connected to the second-first segment through the PIP joint, and a second-third segment connected to the second-second segment through the DIP joint, and the second finger module may further include a second-first wire and a second-second wire connected to the second-first segment to bend/unfold the second-first segment about the MCP joint, a second-third wire and a second-fourth wire connected to the second-second segment to bend/unfold the second-second segment about the PIP joint, and a second-fifth wire and a second-sixth wire connected to the second-third segment to bend/unfold the second-third segment about the DIP joint.

According to one embodiment, the wire driving portion may include a fifth motor configured to provide a driving force to adjust tension of the second-first wire and the second-second wire, a sixth motor configured to provide a driving force to adjust tension of the second-third wire and the second-fourth wire, and a seventh motor configured to provide a driving force to adjust tension of the second-fifth wire and the second-sixth wire.

According to one embodiment, the second finger module may further include a second bearing array, and the second bearing array may be configured to provide movement paths of the second-first wire and the second-second wire from the fifth motor to the second-first segment, provide movement paths of the second-third wire and the second-fourth wire from the sixth motor to the second-second segment, and provide movement paths of the second-fifth wire and the second-sixth wire from the seventh motor to the second-third segment.

According to one embodiment, the second-first wire and the second-second wire may be fixed to both widthwise sides of the second-first segment, the second-third wire, the second-fourth wire, the second-fifth wire, and the second-sixth wire may pass between the second-first wire and the second-second wire, the second-third wire and the second-fourth wire may be fixed to both widthwise sides of the second-second segment, and the second-fifth wire and the second-sixth wire may pass between the second-third wire and the second-fourth wire so as to be fixed to both widthwise sides of the second-third segment.

According to one embodiment, the gear driving portion may include an eighth motor, the second base frame may include a gear group connected to the second finger portion and the eighth motor, and configured to transmit a driving force provided from the eighth motor to the second finger portion, and the gear group may include: a first spur gear axially coupled to a rotation shaft of the eighth motor; a second spur gear gear-coupled to the first spur gear; a third spur gear axially coupled to an opposite lengthwise side of a shaft having one lengthwise side to which the second spur gear is axially coupled; and a bevel gear having one side gear-coupled to the third spur gear and an opposite side connected to an end of the second finger portion.

According to one embodiment, the second finger portion may perform the A/A operation in a path that reciprocates in a direction parallel to a palm surface provided as one side surface of the palm module and in a direction perpendicular to the palm surface.

### Advantageous Effects

According to an embodiment of the present invention, a robot hand having a high degree of freedom may include: a palm module having a set volume; a first finger module including a first base frame detachably coupled to one side of the palm module, and at least two first finger portions connected to the first base frame in one direction and including a plurality of first segments; a second finger module including a second base frame detachably coupled to an opposite side of the palm module, and a second finger portion connected to the second base frame and including a plurality of second segments; and a driving module mounted inside the palm module, and configured to operate the at least two first finger portions and the second finger portion, wherein the driving module includes: a wire driving portion configured to provide a driving force to wires that are individually connected to the first segments and the second segments, respectively; and a gear driving portion configured to provide a driving force to gears that are individually connected to the at least two first finger portions and the second finger portion so as to enable abduction/adduction (A/A) operations of the at least two first finger portions and the second finger portion.

Accordingly, highly functional movements of the finger modules having a total of 16 degrees of freedom can be controlled independently, thereby enabling intuitive control and movement input without the need for a complex calculation formula from the perspective of a user.

According to the embodiment of the present invention, conventional tasks that have been implemented only with simulation results obtained by AI technologies and deep learning technologies, such as a precision tool work and an assembly work, cam be implemented specifically in detail.

In addition, according to the embodiment of the present invention, a robot hand having a high degree of freedom, capable of maximizing user convenience, can be provided.

In other words, according to the embodiment of the present invention, each of the finger modules and the palm module may be detachably coupled to each other, so that assembly can be facilitated, and disassembly can also be facilitated.

In addition, according to the embodiment of the present invention, a driving module configured to operate each of the finger modules may be provided integrally with the palm module, so that a robot hand having a high degree of freedom, in which maintenance and repair are facilitated, can be provided.

### DESCRIPTION OF DRAWINGS

FIG. 1 is a perspective view showing a robot hand having a high degree of freedom according to one embodiment of the present invention.

FIGS. 2 to 8 are views for describing a first finger module of the robot hand having the high degree of freedom according to one embodiment of the present invention.

FIGS. 9 to 13 are views for describing a second finger module of the robot hand having the high degree of freedom according to one embodiment of the present invention.

FIGS. 14 and 15 are views for describing a driving module of the robot hand having the high degree of freedom according to one embodiment of the present invention.

FIGS. 16 to 19 are views for describing various operations of the robot hand having the high degree of freedom according to one embodiment of the present invention.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, shapes and sizes are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

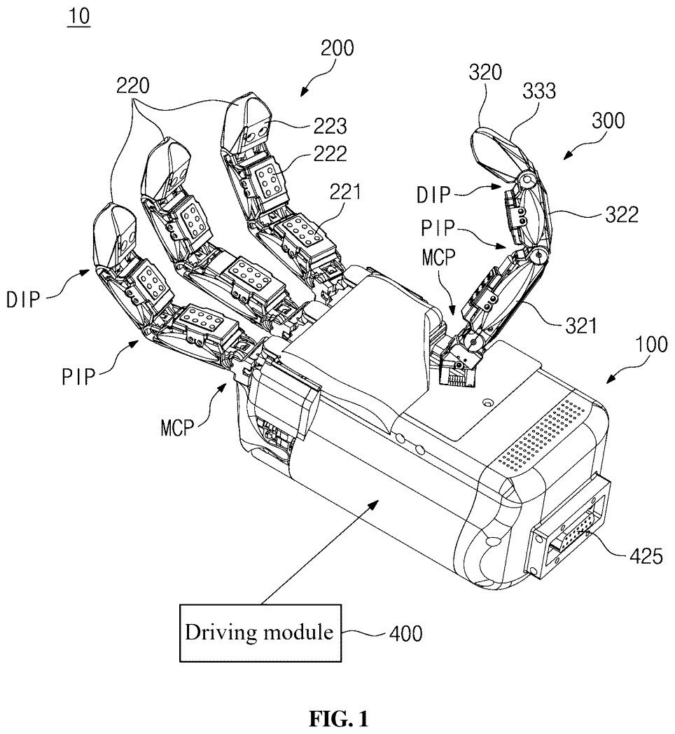

FIGS. 1 to 19 are views for describing a robot hand having a high degree of freedom according to one embodiment of the present invention.

As shown in FIG. 1, according to one embodiment of the present invention, a robot hand 10 having a high degree of freedom may include a palm module 100, a first finger module 200, a second finger module 300, and a driving module 400.

According to one embodiment of the present invention, the palm module 100, the first finger module 200, and the second finger module 300 may be detachably coupled to each other. Accordingly, a user may easily assemble the robot hand 10 having the high degree of freedom, and may easily disassemble the robot hand 10 having the high degree of freedom. In this case, the driving module 400 may be mounted in the palm module 100.

The palm module 100 may have a set volume. One side surface of the palm module 100 may be provided as a palm surface for the first finger module 200 and the second finger module 300.

The first finger module 200 may be connected to one side of the palm surface, and the second finger module 300 may be connected to an opposite side of the palm surface, so that a left or right hand of a human may be imitated.

According to one embodiment of the present invention, a mounting space in which the driving module 400 configured to independently drive segments of a plurality of first finger portions 220 constituting the first finger module 200 and segments of a second finger portion 320 constituting the second finger module 300 is mounted may be provided inside the palm module 100.

The first finger module 200 may be coupled to the palm module 100 so as to function as an index finger, a middle finger, a ring finger, or the like. The first finger module 200 may grip various objects through interaction with the second finger module 300, which functions as a thumb. The first finger module 200 may be connected to the driving module 400 so as to operate in various ways through a driving force provided from the driving module 400.

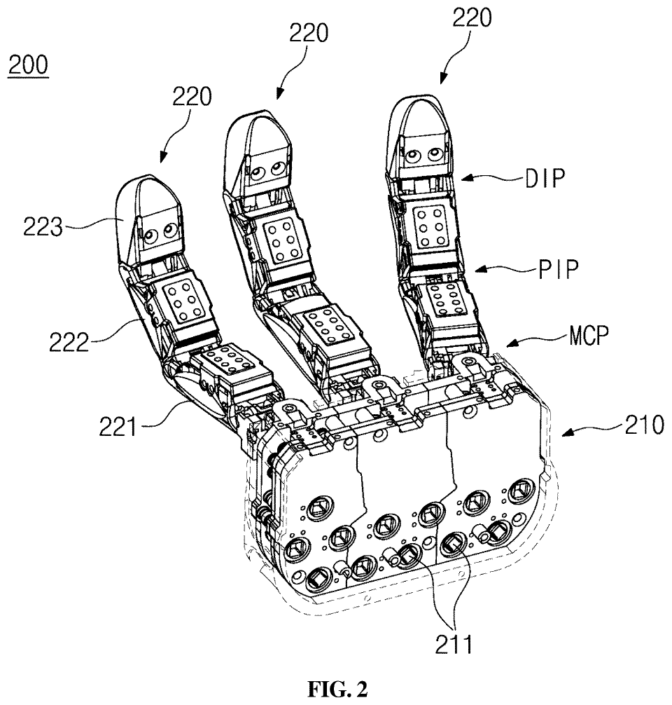

Referring to FIG. 2, according to one embodiment of the present invention, the first finger module 200 may include a first base frame 210 and a first finger portion 220.

The first base frame 210 may support at least two first finger portions 220. The first finger module 200 may be detachably module-coupled to one side of the palm module 100 through the first base frame 210. Accordingly, the at least two first finger portions 220 may be mounted in the palm module 100 at one time or simultaneously by the first base frame 210.

According to one embodiment of the present invention, the first base frame 210 may include a plurality of motor connection ports 211. Rotation shafts of a plurality of motors configured to individually operate the at least two first finger portions 220, more specifically, the segments constituting the first finger portion 220 may be connected to the motor connection ports 211, respectively.

For example, according to one embodiment of the present invention, the first finger portion 220 may include three segments. Three motors may be provided to individually operate the three segments through wires. In this case, three first finger portions 220 may be provided as an index finger, a middle finger, and a ring finger. Accordingly, according to one embodiment of the present invention, the three first finger portions 220 may include a total of nine segments, so that nine motors may be provided to individually operate the nine segments.

Accordingly, the first base frame 210 may include nine motor connection ports 211 to which rotation shafts of the nine motors are connected, respectively.

In this case, among the three segments constituting the first finger portion 220, the segment making contact with the first base frame 210 may additionally perform an abduction/adduction (A/A) operation. Accordingly, an additional motor may be provided to implement the A/A operation of the segment. According to one embodiment of the present invention, the three first finger portions 220 may be provided as the index finger, the middle finger, and the ring finger, so that three motors for implementing an A/A operation of each of the first finger portions 220 may be additionally provided.

Accordingly, according to one embodiment of the present invention, the first base frame 210 may include 12 motor connection ports 211 to which rotation shafts of 12 motors configured to individually operate segments of the three first finger portions 220 are connected, respectively.

In other words, the first base frame 210 may include motor connection ports 211 such that the number of the motor connection ports 211 may correspond to the number of the motors provided to individually operate the segments of the first finger portions 220.

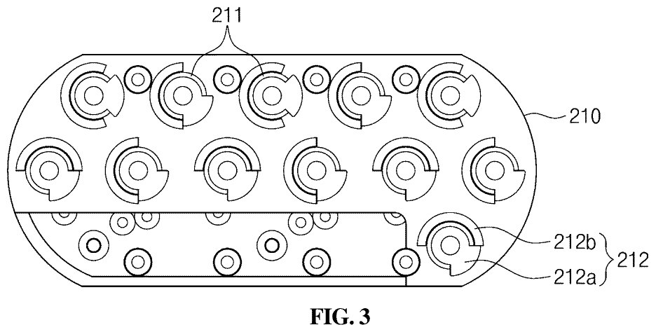

In this case, referring to FIG. 3, each of the motor connection ports 211 may include a stopper member 212. The stopper member 212 may physically restrict a rotation range of the rotation shaft of each of the motors.

Each of the segments of the first finger portion 220 may be bent or unfolded at a predetermined angle, and may perform an A/A operation at a predetermined angle. Accordingly, the stopper member 212 may be provided to prevent an accident or a device failure caused by an excessive operation of the first finger portion 220.

According to one embodiment of the present invention, the stopper member 212 may include a rotation member 212a and a stopper 212b.

The rotation member 212a may be axially coupled to the rotation shaft of the motor. In other words, the rotation member 212a may interwork with the rotation shaft of the motor when the rotation shaft of the motor rotates. A protrusion may protrude in a radial direction on one circumferential side of the rotation member 212a.

The stopper 212b may be provided to face both sides of a rotation path of the protrusion. For example, the stopper 212b may be provided as a ring having a ‘C’ shape.

As the rotation shaft of the motor rotates, the protrusion of the rotation member 212a may also rotate, and, when the protrusion of the rotation member 212a collides with one lengthwise end or an opposite lengthwise end of the stopper 212b, the rotation of the protrusion may be restrained by the stopper 212b.

In other words, when the protrusion collides with the stopper 212b, further rotation of the protrusion may be prevented. Accordingly, the rotation shaft of the motor to which the rotation member 212a including the protrusion is axially coupled may have a rotation range that is physically restricted by the stopper member 212, so that each of the segments constituting the first finger portion 220 may operate safely within a set range.

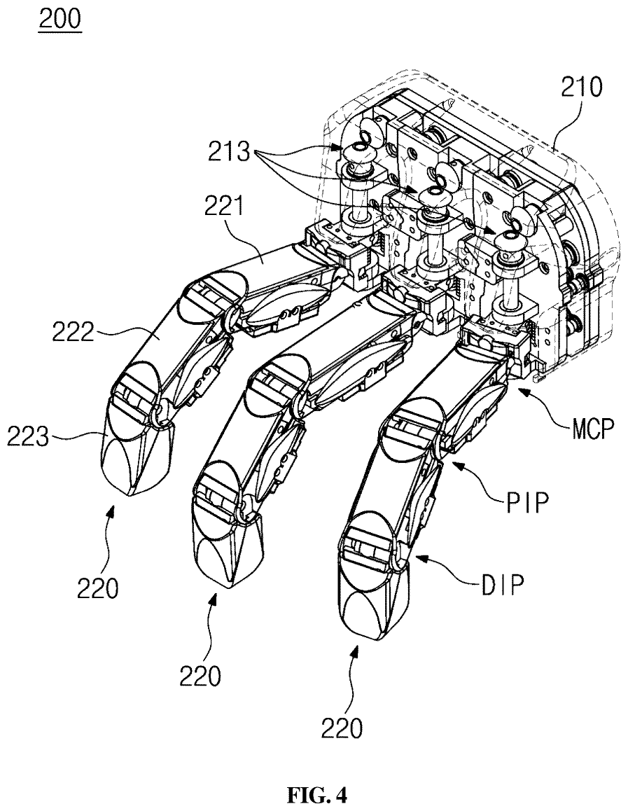

Referring to FIG. 4, the first base frame 210 may include a bevel gear 213. The bevel gear 213 may be connected to a motor configured to provide a driving force so as to transmit the driving force provided from the motor to the first finger portion 220, so that the A/A operation of the first finger portion 220 may be performed. According to one embodiment of the present invention, the three first finger portions 220 that function as an index finger, a middle finger, and a ring finger may be provided, so that three bevel gears 213 may also be provided in one-to-one correspondence with the three first finger portions 220.

According to one embodiment of the present invention, the bevel gear 213 may be mounted in the first base frame 210.

Meanwhile, the first finger portion 220 may be connected to the first base frame 210 so as to be supported by the first base frame 210. The first finger portion 220 may include a plurality of first segments. As described above, the at least two first finger portions 220 including a plurality of first segments may be provided, and connected to the first base frame 210 in one direction.

Hereinafter, the description will be made assuming that the first finger portion 220 includes three first segments, and the three first finger portions 220 that function as an index finger, a middle finger, and a ring finger, respectively, are provided.

According to one embodiment of the present invention, the three first segments constituting the first finger portion 220 may include a first-first segment 221, a first-second segment 222, and a first-third segment 223.

The first-first segment 221 may be connected to the first base frame 210 through a metacarpal (MCP) joint. In addition, the first-first segment 221 and the first-second segment 222 may be connected to each other in a lengthwise direction through a proximal phalanx (PIP) joint. Further, the first-second segment 222 and the first-third segment 223 may be connected to each other in the lengthwise direction through a distal phalanx (DIP) joint.

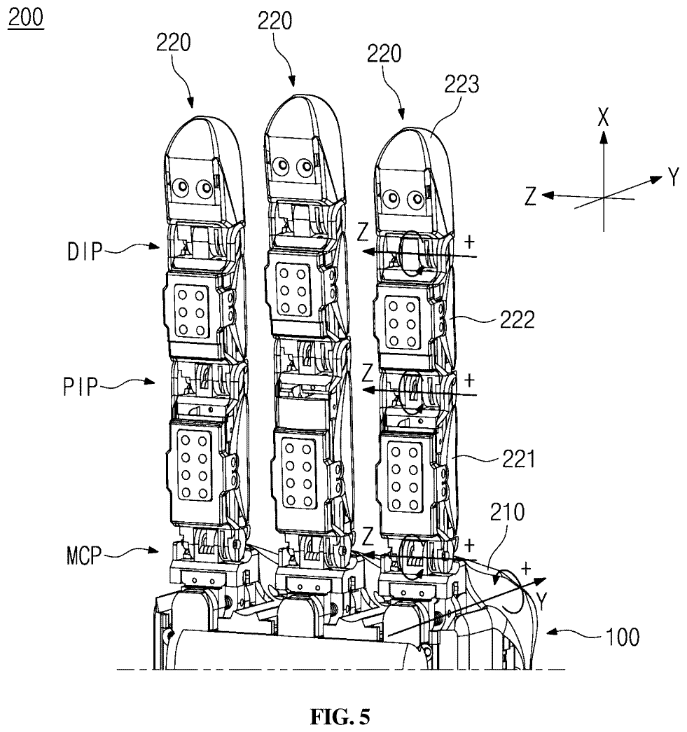

Referring to FIG. 5, the first-first segment 221 may be bent/unfolded about the MCP joint (Z-axis). In addition, the first-second segment 222 may be bent/unfolded about the PIP joint (Z-axis). Further, the first-third segment 223 may be bent/unfolded about the DIP joint (Z-axis).

In this case, the first-first segment 221 may perform an abduction/adduction (A/A) operation about a Y-axis in addition to the bending/unfolding about the MCP joint.

In other words, according to one embodiment of the present invention, the MCP joint may provide 2 degrees of freedom, and each of the PIP joint and the DIP joint may provide 1 degree of freedom. Accordingly, one first finger portion 220 may have 4 degrees of freedom, and the three first finger portions 220 that function as an index finger, a middle finger, and a ring finger may have a total of 12 degrees of freedom.

According to one embodiment of the present invention, the three first finger portions 220 may have a high degree of freedom as described above, so that more precise or detailed movements may be performed, and thus various objects of different sizes or shapes may be gripped stably and efficiently.

Meanwhile, according to one embodiment of the present invention, the first finger module 200 may further include six wires that individually operate the first-first segment 221, the first-second segment 222, and the first-third segment 223.

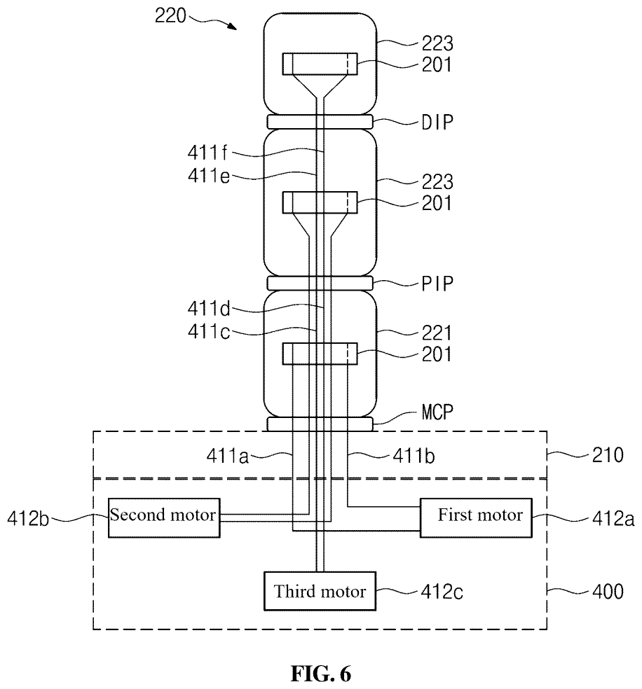

Referring to FIG. 6, the six wires may include a first-first wire 411a, a first-second wire 411b, a first-third wire 411c, a first-fourth wire 411d, a first-fifth wire 411e, and a first-sixth wire 411f.

The first-first wire 411a and the first-second wire 411b may be connected to the first-first segment 221. In detail, the first-first wire 411a and the first-second wire 411b may be fixed to both sides of a wire fixing frame 201 mounted inside the first-first segment 221. In this case, for example, the first-first wire 411a may be wound upward and fixed to the wire fixing frame 201, and the first-second wire 411b may be wound downward and fixed to the wire fixing frame 201.

The first-first wire 411a and the first-second wire 411b may be connected to a first motor 412a of the driving module 400, which will be described below. Tension of each of the first-first wire 411a and the first-second wire 411b may be adjusted when the first motor 412a is driven.

As described above, the tension of each of the first-first wire 411a and the first-second wire 411b may be adjusted by the first motor 412a, so that the first-first segment 221 may be bent or unfolded about the MCP joint.

The first-third wire 411c and the first-fourth wire 411d may be connected to the first-second segment 222. In detail, the first-third wire 411c and the first-fourth wire 411d may be fixed to both sides of a wire fixing frame 201 mounted inside the first-second segment 222. In this case, for example, the first-third wire 411c may be wound upward and fixed to the wire fixing frame 201, and the first-fourth wire 411d may be wound downward and fixed to the wire fixing frame 201.

The first-third wire 411c and the first-fourth wire 411d may be connected to a second motor 412b of the driving module 400, which will be described below. Tension of each of the first-third wire 411c and the first-fourth wire 411d may be adjusted when the second motor 412b is driven.

As described above, the tension of each of the first-third wire 411c and the first-fourth wire 411d may be adjusted by the second motor 412b, so that the first-second segment 222 may be bent or unfolded about the PIP joint.

The first-fifth wire 411e and the first-sixth wire 411f may be connected to the first-third segment 223. In detail, the first-fifth wire 411e and the first-sixth wire 411f may be fixed to both sides of a wire fixing frame 201 mounted inside the first-third segment 223. In this case, for example, the first-fifth wire 411e may be wound upward and fixed to the wire fixing frame 201, and the first-sixth wire 411f may be wound downward and fixed to the wire fixing frame 201.

The first-fifth wire 411e and the first-sixth wire 41 1f may be connected to a third motor 412c of the driving module 400, which will be described below. Tension of each of the first-fifth wire 411e and the first-sixth wire 411f may be adjusted when the third motor 412c is driven.

As described above, the tension of each of the first-fifth wire 411e and the first-sixth wire 411f may be adjusted by the third motor 412c, so that the first-third segment 223 may be bent or unfolded about the DIP joint.

In this case, the six wires 411a to 411f configured to individually operate the first-first segment 221, the first-second segment 222, and the first-third segment 223 may be disposed inside the first finger portion 220. The six wires 411a to 411f may be connected to the first to third motors 412a to 412c connected to the motor connection ports 211 of the first base frame 210.

In this case, according to one embodiment of the present invention, the three first finger portions 220 that function as an index finger, a middle finger, and a ring finger may be connected to the first base frame 210, so that a total of 18 wires, that is, three wire sets in which the first-first wire 411a, the first-second wire 411b, the first-third wire 411c, the first-fourth wire 411d, the first-fifth wire 411e, and the first-sixth wire 411f are defined as one set, may be disposed inside the first base frame 210. Accordingly, a large number of wires may interfere with each other, that is, may be tangled or twisted with each other, inside the first base frame 210, so that a problem may arise in smoothly individually operating the first-first segment 221, the first-second segment 222, and the first-third segment 223 constituting the first finger portion 220.

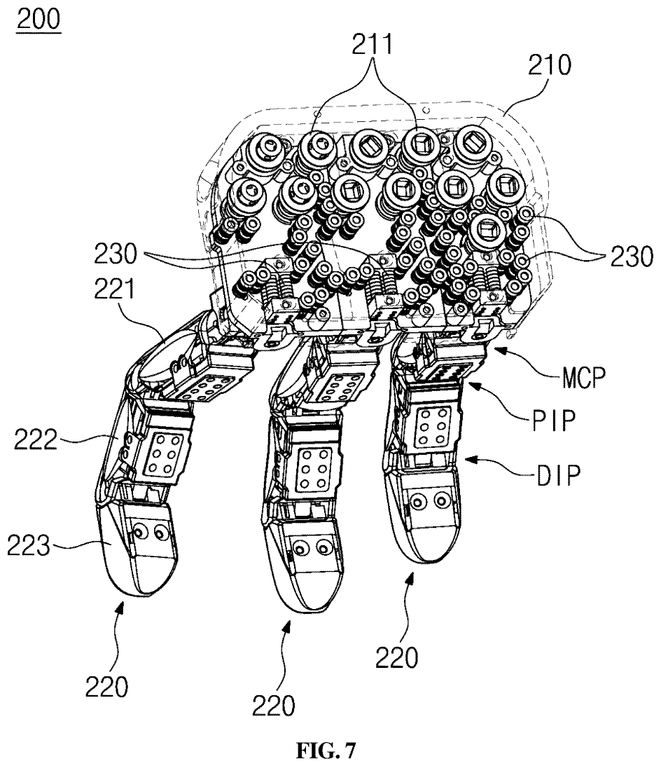

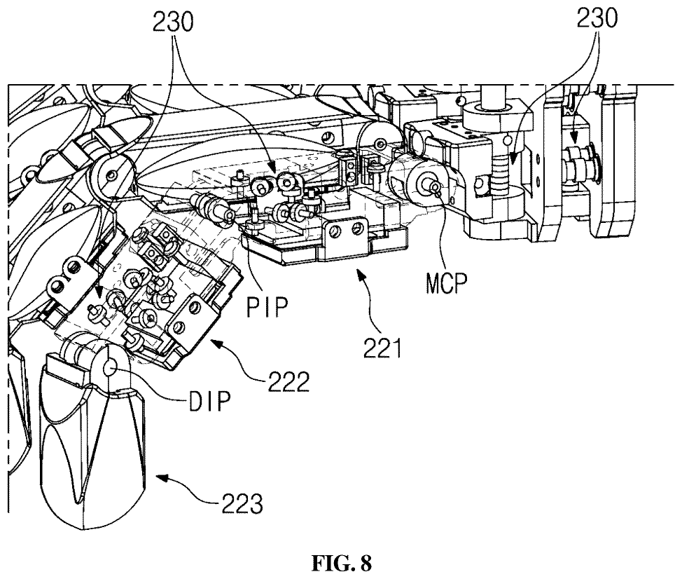

Accordingly, as shown in FIGS. 7 and 8, according to one embodiment of the present invention, the first finger module 200 may further include a first bearing array 230.

The first bearing array 230 may include a combination of a plurality of bearings. The first bearing array 230 may be provided inside the first base frame 210 and the first finger portion 220.

According to one embodiment of the present invention, the first bearing array 230 may provide movement paths of the first-first wire 411a and the first-second wire 411b from the first motor 412a to the first-first segment 221. Accordingly, the first-first wire 411a and the first-second wire 411b may be moved to the first-first segment 221 while being guided by the bearings constituting the first bearing array 230, and fixed to the wire fixing frame 201 mounted inside the first-first segment 221.

In addition, the first bearing array 230 may provide movement paths of the first-third wire 411c and the first-fourth wire 411d from the second motor 412b to the first-second segment 222. Accordingly, the first-third wire 411c and the first-fourth wire 411d may be moved to the first-second segment 222 while being guided by the bearings constituting the first bearing array 230, and fixed to the wire fixing frame 201 mounted inside the first-second segment 222.

In addition, the first bearing array 230 may provide movement paths of the first-fifth wire 411e and the first-sixth wire 411f from the third motor 412c to the first-third segment 223. Accordingly, the first-fifth wire 411e and the first-sixth wire 411f may be moved to the first-third segment 223 while being guided by the bearings constituting the first bearing array 230, and fixed to the wire fixing frame 201 mounted inside the first-third segment 223.

Referring again to FIG. 6, the first-first wire 411a and the first-second wire 411b may be guided by dedicated first bearing arrays 230 to the first-first segment 221, and fixed to both sides of the wire fixing frame 201.

In this case, each of the first-third wire 411c, the first-fourth wire 411d, the first-fifth wire 411e, and the first-sixth wire 411f may be guided by the dedicated first bearing arrays 230 to pass between the first-first wire 411a and the first-second wire 411b.

The first-third wire 411c and the first-fourth wire 411d, which are guided by the dedicated first bearing arrays 230 to reach the first-second segment 222, may be fixed to both sides of the wire fixing frame 201 mounted inside the first-second segment 222.

In this case, the first-fifth wire 411e and the first-sixth wire 411f may be guided by the dedicated first bearing arrays 230 to pass between the first-third wire 411c and the first-fourth wire 411d.

The first-fifth wire 411e and the first-sixth wire 411f, which are guided by the dedicated first bearing arrays 230 to reach the first-third segment 223, may be fixed to both sides of the wire fixing frame 201 mounted inside the first-third segment 223.

As described above, the first-first wire 411a, the first-second wire 411b, the first-third wire 411c, the first-fourth wire 411d, the first-fifth wire 411e, and the first-sixth wire 411f may be disposed without interfering with each other or with minimal interference with each other even inside the first finger portion 220 through the dedicated first bearing arrays 230, respectively.

The second finger module 300 may be coupled to the palm module 100 to function as a thumb. The second finger module 300 may grip various objects through interaction with the first finger module 200, which functions as an index finger, a middle finger, or a ring finger. The second finger module 300 may be connected to the driving module 400 so as to operate in various ways through a driving force provided from the driving module 400.

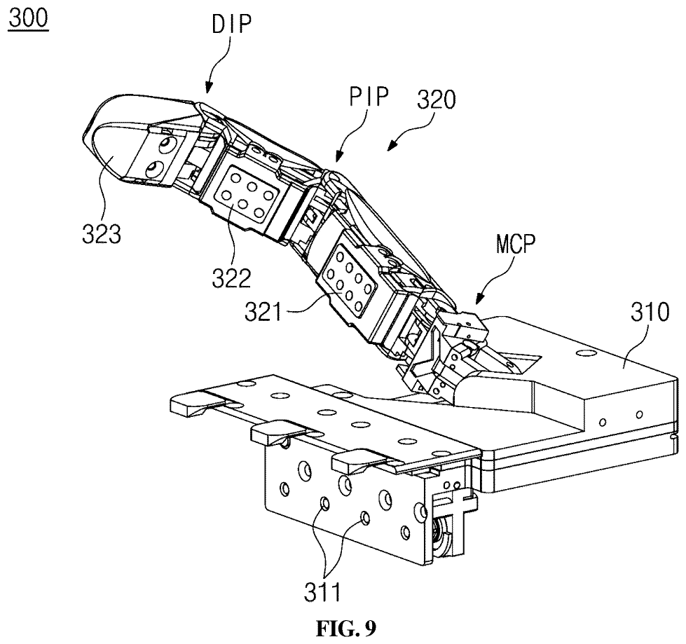

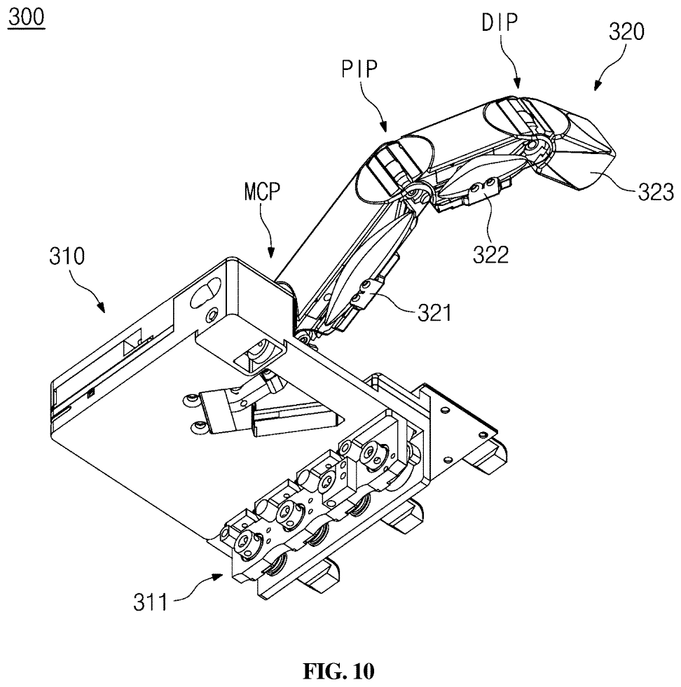

Referring to FIGS. 9 and 10, according to one embodiment of the present invention, the second finger module 300 may include a second base frame 310 and a second finger portion 320.

The second base frame 310 may support the second finger portion 320. The second finger module 300 may be detachably module-coupled to an opposite side of the palm module 100 having one side to which the first finger module 200 is detachably module-coupled through the second base frame 310. Accordingly, according to one embodiment of the present invention, the robot hand 10 having the high degree of freedom may be easily assembled.

According to one embodiment of the present invention, the second base frame 310 may include a plurality of motor connection ports 311. Rotation shafts of a plurality of motors configured to individually operate the segments constituting the second finger portion 320 may be connected to the connection ports 311, respectively.

For example, according to one embodiment of the present invention, the second finger portion 320 may include three second segments, that is, a second-first segment 321, a second-second segment 322, and a second-third segment 323. Three motors, that is, a fifth motor 414a, a sixth motor 414b, and a seventh motor 414c, may be provided to individually operate the second-first segment 321, the second-second segment 322, and the second-third segment 323 through wires.

Accordingly, the second base frame 310 may include three motor connection ports 311 to which rotation shafts of the fifth motor 414a, the sixth motor 414b, and the seventh motor 414c are connected, respectively.

In this case, among the second-first segment 321, the second-second segment 322, and the second-third segment 323 constituting the second finger portion 320, the second-first segment 321 making contact with the second base frame 310 may additionally perform an A/A operation. Accordingly, an additional motor, that is, an eighth motor 422, may be provided to implement the A/A operation of the second-first segment 321.

Accordingly, according to one embodiment of the present invention, the second base frame 310 in may include four motor connection ports 311 to which rotation shafts of four motors configured to individually operate the second-first segment 321, the second-second segment 322, and the second-third segment 323 constituting the second finger portion 320, that is, the fifth motor 414a, the sixth motor 414b, the seventh motor 414c, and the eighth motor 422, are connected, respectively.

In this case, although not shown in the drawings, each of the motor connection ports 311 may include a stopper member configured to perform the same function as the stopper member (212 in FIG. 3) provided in the first finger module (200 in FIG. 1), so that rotation ranges of the rotation shafts of the fifth motor 414a, the sixth motor 414b, the seventh motor 414c, and the eighth motor 422 may be physically restricted.

Meanwhile, the second base frame 310 may include a gear group. The gear group may be connected to the eighth motor 422 configured to provide a driving force so as to transmit the driving force provided from the eighth motor 422 to the second finger portion 320, so that the A/A operation of the second finger portion 320 may be performed.

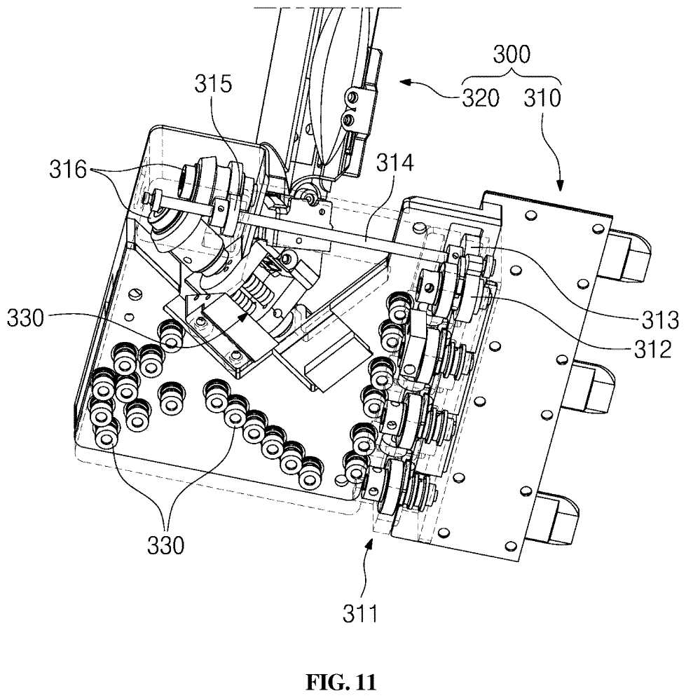

Referring to FIG. 11, the gear group may include a combination of a first spur gear 312, a second spur gear 313, a third spur gear 315, and a bevel gear 316.

The first spur gear 312 may be axially coupled to the rotation shaft of the eighth motor 422. The second spur gear 313 may be gear-coupled to the first spur gear 312. The third spur gear 315 may be axially coupled to an opposite lengthwise side of a shaft 314 having one lengthwise side to which the second spur gear 313 is axially coupled. The bevel gear 316 may have one side gear-coupled to the third spur gear 315 and an opposite connected to an end of the second finger portion 320, that is, an end of the second-first segment 321 of the second finger portion 320.

Through the gear group, the second finger portion 320, which functions as a thumb, may perform the A/A operation in a path that reciprocates in a direction parallel to a palm surface provided as one side surface of the palm module 100 and in a direction perpendicular to the palm surface.

In this case, a range in which the second finger portion 320, which functions as a thumb, performs the A/A operation through the gear group may be relatively larger than a range in which the first finger portion 220, which functions as one of an index finger, a middle finger, and a ring finger, performs the A/A operation through the bevel gear (213 in FIG. 4). For example, according to one embodiment of the present invention, the range in which the second finger portion 320, which functions as a thumb, performs the A/A operation through the gear group may be 0° to 90°, and the range in which the first finger portion 220, which functions as one of an index finger, a middle finger, and a ring finger, performs the A/A operation through the bevel gear (213 in FIG. 4) may be −20° to 20°.

Meanwhile, the second finger portion 320 may be connected to the second base frame 310 so as to be supported by the second base frame 310. The second finger portion 320 may include a plurality of second segments connected in one direction. According to one embodiment of the present invention, the second finger portion 320 may function as a thumb, so that one second finger portion 320 may be connected to the second base frame 310.

Hereinafter, the description will be made assuming that the second finger portion 320 includes three second segments, and the one second finger portion 320 that functions as a thumb is provided.

According to one embodiment of the present invention, the three second segments constituting the second finger portion 320 may include a second-first segment 321, a second-second segment 322, and a second-third segment 323.

The second-first segment 321 may be connected to the second base frame 310 through a metacarpal (MCP) joint. In addition, the second-first segment 321 and the second-second segment 322 may be connected to each other in a lengthwise direction through a proximal phalanx (PIP) joint. Further, the second-second segment 322 and the second-third segment 323 may be connected to each other in the lengthwise direction through a distal phalanx (DIP) joint.

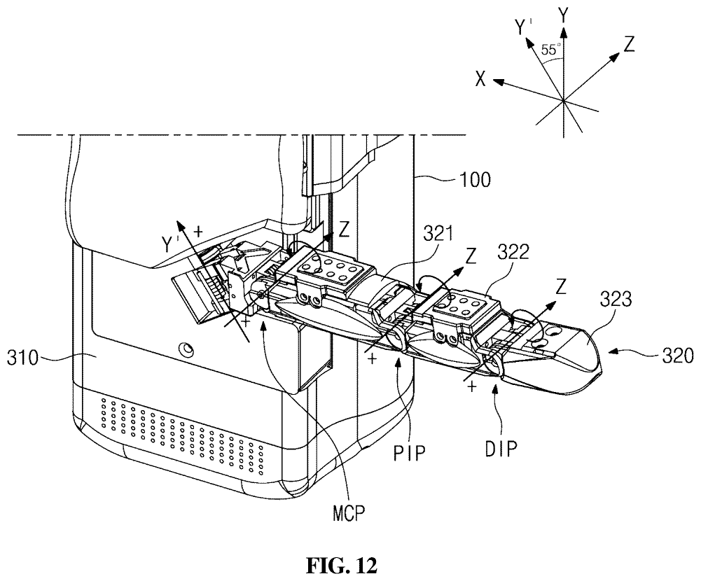

Referring to FIG. 12, the second-first segment 321 may be bent/unfolded about the MCP joint (Z-axis). In addition, the second-second segment 322 may be bent/unfolded about the PIP joint axis (Z-axis). Further, the second-third segment 323 may be bent/unfolded about the DIP joint (Z-axis).

In this case, the second-first segment 321 may perform an abduction/adduction (A/A) operation about a Y′-axis inclined at 55° from a Y-axis in addition to the bending/unfolding about the MCP joint.

In other words, according to one embodiment of the present invention, the MCP joint may provide 2 degrees of freedom, and each of the PIP joint and the DIP joint may provide 1 degree of freedom. Accordingly, one second finger portion 320 may have 4 degrees of freedom.

According to an embodiment of the present invention, the second finger portion 320 may have a high degree of freedom as described above, so that more precise or detailed thumb movements may be performed, and thus various objects of different sizes and shapes may be gripped stably and efficiently through interaction with the three first finger portions (220 in FIG. 2) having the high degree of freedom, similar to the second finger portion 320.

Meanwhile, according to one embodiment of the present invention, the second finger module 300 may further include six wires that individually operate the second-first segment 321, the second-second segment 322, and the second-third segment 323.

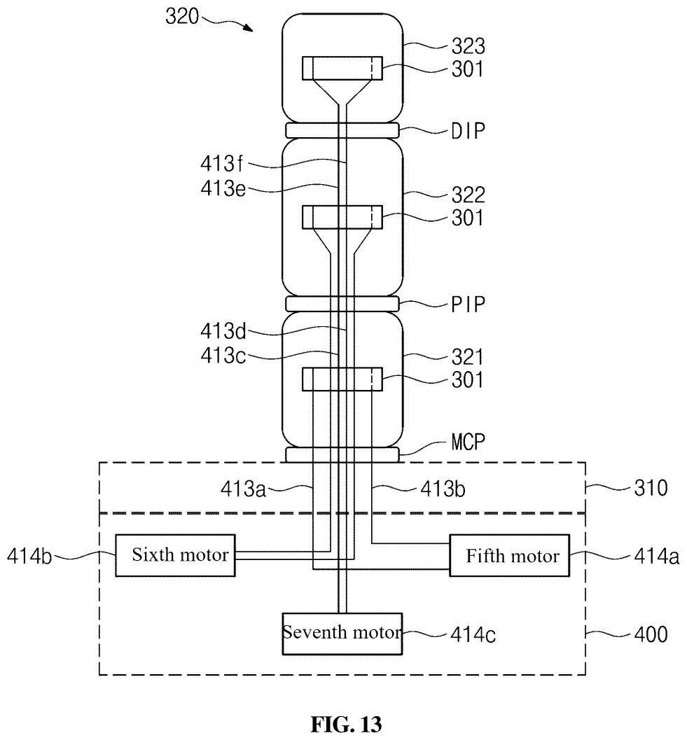

Referring to FIG. 13, the six wires may include a second-first wire 413a, a second-second wire 413b, a second-third wire 413c, a second-fourth wire 413d, a second-fifth wire 413e, and a second-sixth wire 413f.

The second-first wire 413a and the second-second wire 413b may be connected to the second-first segment 321. In detail, the second-first wire 413a and the second-second wire 413b may be fixed to both sides of a wire fixing frame 301 mounted inside the second-first segment 321. In this case, the second-first wire 413a may be wound upward and fixed to the wire fixing frame 301, and the second-second wire 413b may be wound downward and fixed to the wire fixing frame 301.

The second-first wire 413a and the second-second wire 413b may be connected to a fifth motor 414a of the driving module 400, which will be described below. Tension of each of the second-first wire 413a and the second-second wire 413b may be adjusted when the fifth motor 414a is driven.

As described above, the tension of each of the second-first wire 413a and the second-second wire 413b may be adjusted by the fifth motor 414a, so that the second-first segment 321 may be bent or unfolded about the MCP joint.

The second-third wire 413c and the second-fourth wire 413d may be connected to the second-second segment 322. In detail, the second-third wire 413c and the second-fourth wire 413d may be fixed to both sides of a wire fixing frame 301 mounted inside the second-second segment 322. In this case, the second-third wire 413c may be wound upward and fixed to the wire fixing frame 301, and the second-fourth wire 413d may be wound downward and fixed to the wire fixing frame 301.

The second-third wire 413c and the second-fourth wire 413d may be connected to a sixth motor 414b of the driving module 400, which will be described below. Tension of each of the second-third wire 413c and the second-fourth wire 413d may be adjusted when the sixth motor 414b is driven.

As described above, the tension of each of the second-third wire 413c and the second-fourth wire 413d may be adjusted by the sixth motor 414b, so that the second-second segment 322 may be bent or unfolded about the PIP joint.

The second-fifth wire 413e and the second-sixth wire 413f may be connected to the second-third segment 323. In detail, the second-fifth wire 413e and the second-sixth wire 413f may be fixed to both sides of a wire fixing frame 301 mounted inside the second-3 segment 323. In this case, the second-fifth wire 413e may be wound upward and fixed to the wire fixing frame 301, and the second-sixth wire 413f may be wound downward and fixed to the wire fixing frame 301.

The second-fifth wire 413e and the second-sixth wire 413f may be connected to a seventh motor 414c of the driving module 400, which will be described below. Tension of each of the second-fifth wire 413e and the second-sixth wire 413f may be adjusted when the seventh motor 414c is driven.

As described above, the tension of each of the second-fifth wire 413e and the second-sixth wire 413f may be adjusted by the seventh motor 414c, so that the second-third segment 323 may be bent or unfolded about the DIP joint.

Referring again to FIG. 11, the second finger module 300 may further include a second bearing array 330 to prevent interference among six wires disposed inside the second base frame 310 and the second finger portion 320, that is, a second-first wire 413a, a second-second wire 413b, a second-third wire 413c, a second-fourth wire 413d, a second-fifth wire 413e, and a second-sixth wire 413f.

Similar to the first bearing array 230 in FIG. 7, the second bearing array 330 may include a combination of a plurality of bearings. The second bearing array 330 may be provided inside the second base frame 310 and the second finger portion 320.

According to one embodiment of the present invention, the second bearing array 330 may provide movement paths of the second-first wire 413a and the second-second wire 413b from the fifth motor 414a to the second-first segment 321. Accordingly, the second-first wire 413a and the second-second wire 413b may be to the second-first segment 321 while being guided by the bearings constituting the second bearing array 330, and fixed to the wire fixing frame 301 mounted inside the second-first segment 321.

In addition, the second bearing array 330 may provide movement paths of the second-third wire 413c and the second-fourth wire 413d from the sixth motor 414b to the second-second segment 322. Accordingly, the second-third wire 413c and the second-fourth wire 413d may be moved to the second-second segment 322 while being guided by the bearings constituting the second bearing array 330, and fixed to the wire fixing frame 301 mounted inside the second-second segment 322.

In addition, the second bearing array 330 may provide movement paths of the second-fifth wire 413e and the second-sixth wire 413f from the seventh motor 414c to the second-third segment 323. Accordingly, the second-fifth wire 413e and the second-sixth wire 413f may be moved to the second-third segment 323 while being guided by the bearings constituting the second bearing array 330, and fixed to the wire fixing frame 301 mounted inside the second-third segment 323.

Referring again to FIG. 13, the second-first wire 413a and the second-second wire 413b may be guided by dedicated second bearing arrays 330 to the second-first segment 321, and fixed to both sides of the wire fixing frame 301.

In this case, each of the second-third wire 413c, the second-fourth wire 413d, the second-fifth wire 413e, and the second-sixth wire 413f may be guided by the dedicated second bearing arrays 330 to pass between the second-first wire 413a and the second-second wire 413b.

The second-third wire 413c and the second-fourth wire 413d, which are guided by the dedicated second bearing arrays 330 to reach the second-second segment 322, may be fixed to both sides of the wire fixing frame 301 mounted inside the second-second segment 322.

In this case, the second-fifth wire 413e and the second-sixth wire 413f may be guided by the dedicated second bearing arrays 330 to pass between the second-third wire 413c and the second-fourth wire 413d.

The second-fifth wire 413e and the second-sixth wire 413f, which are guided by the dedicated second bearing arrays 330 to reach the second-third segment 323, may be fixed to both sides of the wire fixing frame 301 mounted inside the second-third segment 323.

As described above, the second-first wire 413a, the second-second wire 413b, the second-third wire 413c, the second-fourth wire 413d, the second-fifth wire 413e, and the second-sixth wire 413f may be disposed without interfering with each other or with minimal interference with each other even inside the second finger portion 320 through the dedicated second bearing arrays 330, respectively.

Referring again to FIG. 1, the driving module 400 may be mounted inside the palm module 100. The driving module 400 may operate three first finger portions 220 that function as an index finger, a middle finger, and a ring finger, and one second finger portion 320 that functions as a thumb.

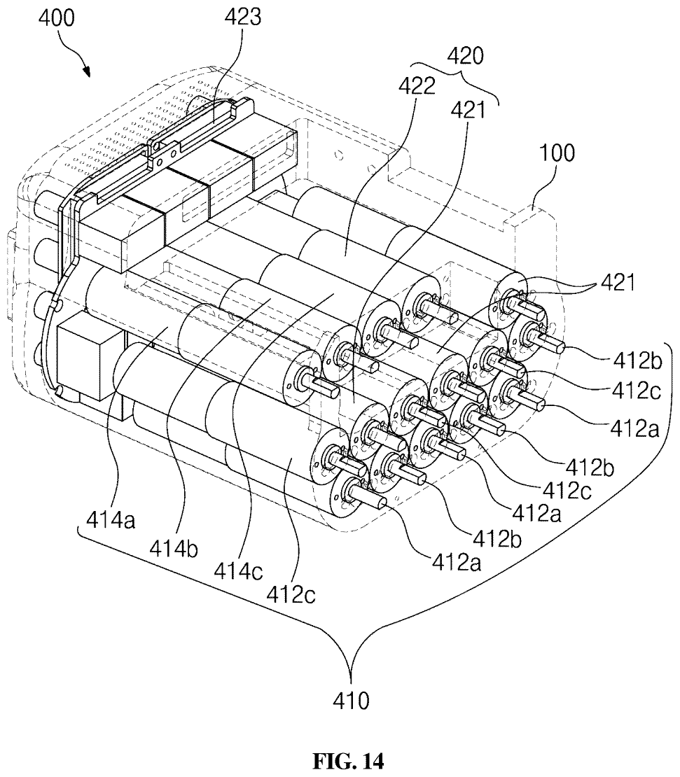

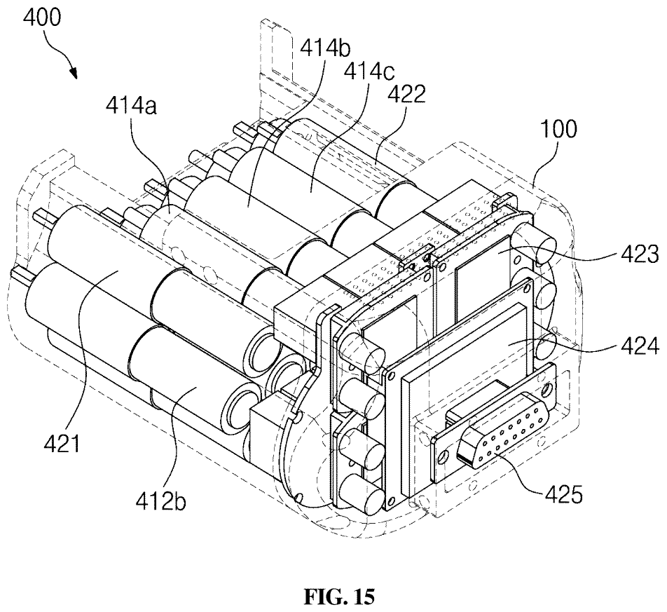

Referring to FIGS. 14 and 15, according to one embodiment of the present invention, the driving module 400 may include a wire driving portion 410 and a gear driving portion 420.

For example, the wire driving portion 410 may provide a driving force to the first-first wire 411a and the first-second wire 411b connected to the first segments, that is, the first-first segment 221 constituting the first finger portion 220 that functions as an index finger, so that the first-first segment 221 may be bent unfolded about the MCP joint.

To this end, the wire driving portion 410 may include a first motor 412a connected to opposite lengthwise ends of the first-first wire 411a and the first-second wire 411b having one lengthwise ends connected to the first-first segment 221, and configured to provide a driving force for adjusting tension of the first-first wire 411a and the first-second wire 411b. The first motor 412a may be a combination of a reducer and a brushless (BLDC) motor.

In addition, the wire driving portion 410 may provide a driving force to the first-third wire 411c and the first-fourth wire 411d connected to the first-second segment 222 constituting the first finger portion 220 that functions as an index finger, so that the first-second segment 222 may be bent or unfolded about the PIP joint.

To this end, the wire driving portion 410 may include a second motor 412b connected to opposite lengthwise ends of the first-third wire 411c and the first-fourth wire 411d having one lengthwise ends connected to the first-second segment 222, and configured to provide a driving force for adjusting tension of the first-third wire 411c and the first-fourth wire 411d. The second motor 412b may be a combination of a reducer and a brushless (BLDC) motor.

In addition, the wire driving portion 410 may provide a driving force to the first-fifth wire 411e and the first-sixth wire 41 1f connected to the first-third segment 223 constituting the first finger portion 220 that functions as an index finger, so that the first-third segment 223 may be bent or unfolded about the DIP joint.

To this end, the wire driving portion 410 may include a third motor 412c connected to opposite lengthwise ends of the first-fifth wire 411e and the first-sixth wire 411f having one lengthwise ends connected to the first-third segment 223, and configured to provide a driving force for adjusting tension of the first-fifth wire 411e and the first-sixth wire 411f. The third motor 412c may be a combination of a reducer and a brushless (BLDC) motor.

The first to third motors 412a to 412c may constitute one motor set configured to operate the first finger portion 220 that functions as an index finger.

Similarly, the wire driving portion 410 may provide a driving force to each of the wires connected to each of the segments of the first finger portion 220, which functions as a middle finger, and the wires connected to each of the segments of the first finger portion 220, which functions as a ring finger.

To this end, the wire driving portion 410 may include a motor set configured to operate the first finger portion 220, which functions as a middle finger, and a motor set configured to operate the first finger portion 220, which functions as a ring finger.

In addition, the wire driving portion 410 may provide a driving force to the second-first wire 413a and the second-second wire 413b connected to the second-first segment 321 constituting the second finger portion 320 that functions as a thumb, so that the second-first segment 321 may be bent or unfolded about the MCP joint.

To this end, the wire driving portion 410 may include a fifth motor 414a connected to opposite lengthwise ends of the second-first wire 413a and the second-second wire 413b having one lengthwise ends connected to the second-first segment 321, and configured to provide a driving force for adjusting tension of the second-first wire 413a and the second-second wire 413b. The fifth motor 414a may be a combination of a reducer and a brushless (BLDC) motor.

In addition, the wire driving portion 410 may provide a driving force to the second-third wire 413c and the second-fourth wire 413d connected to the second-second segment 322 constituting the second finger portion 320 that functions as a thumb, so that the second-second segment 322 may be bent or unfolded about the PIP joint.

To this end, the wire driving portion 410 may include a sixth motor 414b connected to opposite lengthwise ends of the second-third wire 413c and the second-fourth wire 413d having one lengthwise ends connected to the second-second segment 322, and configured to provide a driving force for adjusting tension of the second-third wire 413c and the second-fourth wire 413d. The sixth motor 414b may be a combination of a reducer and a brushless (BLDC) motor.

In addition, the wire driving portion 410 may provide a driving force to the second-fifth wire 413e and the second-sixth wire 413f connected to the second-third segment 323 constituting the second finger portion 320 that functions as a thumb, so that the second-third segment 323 may be bent or unfolded about the DIP joint.

To this end, the wire driving portion 410 may include a seventh motor 414c connected to opposite lengthwise ends of the second-fifth wire 413e and the second-sixth wire 413f having one lengthwise ends connected to the second-third segment 323, and configured to provide a driving force for adjusting tension of the second-fifth wire 413e and the second-sixth wire 413f. The seventh motor 414c may be a combination of a reducer and a brushless (BLDC) motor.

For example, the gear driving portion 420 may provide a driving force to the bevel gear 213 connected to the first-first segment 221 of the first finger portion 220, which functions as an index finger, to allow the first finger portion 220, which functions as an index finger, to perform an abduction operation or an adduction operation.

To this end, the gear driving portion 420 may include a fourth motor 421 connected to the bevel gear 213 installed in the first base frame 210, and configured to transmit a driving force to the first-first segment 221 through the bevel gear 213. The fourth motor 421 may be a combination of a reducer and a brushless (BLDC) motor.

The fourth motor 421 may be added to the motor set including the first to third motors 412a to 412c configured to operate the first finger portion 220 that functions as an index finger.

According to one embodiment of the present invention, the first to fourth motors 412a, 412b, 412c, and 421 configured to operate the first finger portion 220 that functions as an index finger may be arranged, for example, in two layers inside the palm module 100.

In addition, for example, the gear driving portion 420 may provide a driving force to the bevel gear 213 connected to the first-first segment 221 of the first finger portion 220, which functions as a middle finger, to allow the first finger portion 220, which functions as a middle finger, to perform an abduction operation or an adduction operation.

To this end, the gear driving portion 420 may include a fourth motor 421 connected to the bevel gear 213 installed in the first base frame 210, and configured to transmit a driving force to the first-first segment 221 through the bevel gear 213.

The fourth motor 421 may be added to the motor set including the first to third motors 412a to 412c configured to operate the first finger portion 220 that functions as a middle finger.

According to one embodiment of the present invention, the first to fourth motors 412a, 412b, 412c, and 421 configured to operate the first finger portion 220 that functions as a middle finger may be arranged, for example, in two layers on a side of the motors configured to operate the first finger portion 220 that functions as an index finger inside the palm module 100.

In addition, for example, the gear driving portion 420 may provide a driving force to the bevel gear 213 connected to the first-first segment 221 of the first finger portion 220, which functions as a ring finger, to allow the first finger portion 220, which functions as a ring finger, to perform an abduction operation or an adduction operation.

To this end, the gear driving portion 420 may include a fourth motor 421 connected to the bevel gear 213 installed in the first base frame 210, and configured to transmit a driving force to the first-first segment 221 through the bevel gear 213.

The fourth motor 421 may be added to the motor set including the first to third motors 412a to 412c configured to operate the first finger portion 220 that functions as a ring finger.

According to one embodiment of the present invention, the first to fourth motors 412a, 412b, 412c, and 421 configured to operate the first finger portion 220 that functions as a ring finger may be arranged, for example, in two layers on a side of the motors configured to operate the first finger portion 220 that functions as a middle finger inside the palm module 100.

In other words, according to one embodiment of the present invention, a total of 12 motors configured to operate the three first finger portions 220 that function as an index finger, a middle finger, and a ring finger may be arranged in two layers inside the palm module 100.

In addition, the gear driving portion 420 may provide a driving force to the gear group connected to the second-first segment 321 of the second finger portion 320, which functions as a thumb, to allow the second finger portion 320, which functions as a thumb, to perform an abduction operation or an adduction operation.

To this end, the gear driving portion 420 may include an eighth motor 422 installed in the second base frame 310, connected to the gear group including the combination of the first spur gear 312, the second spur gear 313, the third spur gear 315, and the bevel gear 316, and configured to transmit a driving force to the second-first segment 321 through the gear group. The eighth motor 422 may be a combination of a reducer and a brushless (BLDC) motor.

The eighth motor 422 may be added to the motor set including the fifth motor 414a, the sixth motor 414b, and the seventh motor 414c configured to operate the second finger portion 320 that functions as an index finger.

According to one embodiment of the present invention, as described above, the fifth to eighth motors 414a, 414b, 414c, and 422 configured to operate the second finger portion 320 that functions as a thumb may be arranged in a single layer inside the palm module 100.

In this case, the fifth to eighth motors 414a, 414b, 414c, and 422 may operate the three first finger portions 220 that function as an index finger, a middle finger, and a ring finger, respectively, and may be arranged in a single layer on three motor sets arranged in two layers.

As described above, according to one embodiment of the present invention, a total of 16 motors configured to individually operate the nine segments constituting the three first finger portions 220 and the three segments constituting the one second finger portion 320 may be compactly mounted inside the palm module 100.

Meanwhile, according to one embodiment of the present invention, the driving module 400 may further include a motor driver 423 and a control and communication board 424, which are configured to control the total of 16 motors. The motor driver 423 and the control and communication board 424 may be mounted inside the palm module 100 so as to be connected to the 16 motors.

In addition, the driving module 400 may further include an external connector 425 connected to the control and communication board 424, and configured to receive a power from an outside or communicate with the outside. In this case, a connection terminal of the external connector 425 may be exposed to the outside on one surface of the palm module 100.

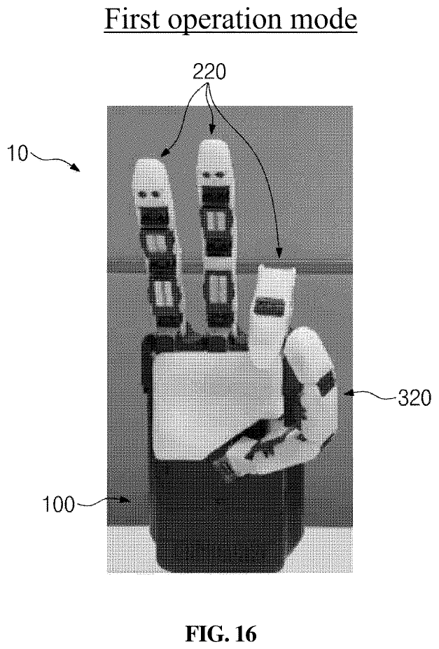

FIGS. 16 to 19 are views for describing various operations of the robot hand having the high degree of freedom according to one embodiment of the present invention.

As shown in FIG. 16, according to one embodiment of the present invention, the robot hand 10 having the high degree of freedom may be switched into a first operation mode in which two first finger portions 220 that function as a middle finger and a ring finger are unfolded, and the first finger portion 220 that functions as an index finger and the second finger portion 320 that functions as a thumb are bent, so that a distal end of the first finger portion 220 that functions as an index finger and a distal end of the second finger portion 320 may make contact with each other.

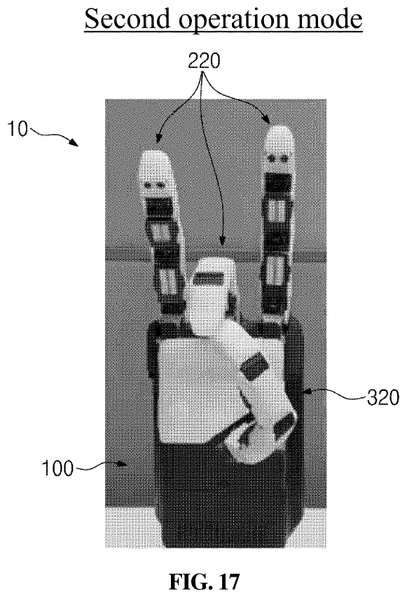

In addition, as shown in FIG. 17, according to one embodiment of the present invention, the robot hand 10 having the high degree of freedom may be switched into a second operation mode in which two first finger portions 220 that function as an index finger and a ring finger are unfolded, and the first finger portion 220 that functions as a middle finger and the second finger portion 320 that functions as a thumb are bent, so that a distal end of the first finger portion 220 that functions as a middle finger and the distal end of the second finger portion 320 may make contact with each other. In this case, the second finger portion 320 may perform the A/A operation so that the distal end of the second finger portion 320 may make contact with the distal end of the first finger portion 220 that functions as a middle finger.

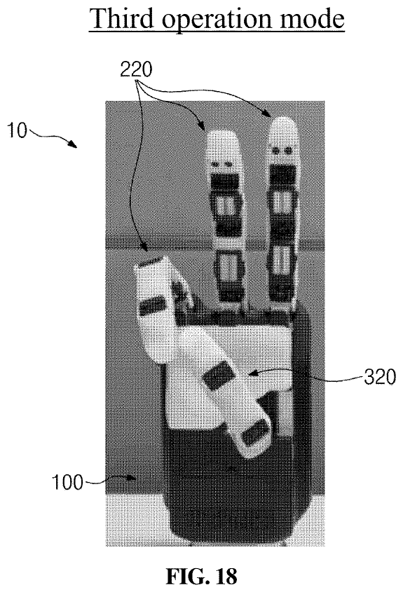

In addition, as shown in FIG. 18, according to one embodiment of the present invention, the robot hand 10 having the high degree of freedom may be switched into a third operation mode in which two first finger portions 220 that function as an index finger and a middle finger are unfolded, and the first finger portion 220 that functions as a ring finger and the second finger portion 320 that functions as a thumb are bent while performing the A/A operation, so that a distal end of the first finger portion 220 that functions as a ring finger and the distal end of the second finger portion 320 may make contact with each other.

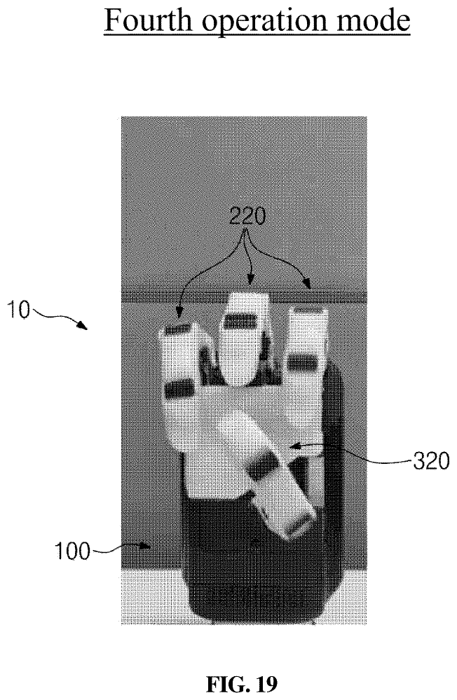

In addition, as shown in FIG. 19, according to one embodiment of the present invention, the robot hand 10 having the high degree of freedom may be switched into a fourth operation mode in which all three first finger portions 220 that function as an index finger, a middle finger, and a ring finger are bent, and the second finger portion 320 that functions as a thumb is bent while performing the A/A operation, so that a shape of a clenched fist or a shape of gripping an object may be formed.

According to one embodiment of the present invention, the robot hand 10 having the high degree of freedom may independently drive the three first finger portions 220 that function as an index finger, a middle finger, and a ring finger, which have 4 degrees of freedom, respectively, and the one second finger portion 320 that functions as a thumb, which have 4 degrees of freedom. In this case, according to one embodiment of the present invention, all the three segments constituting the first finger portion 220 that functions as an index finger, the three segments constituting the first finger portion 220 that functions as a middle finger, the three segments constituting the first finger portion 220 that functions as a ring finger, and the three segments constituting the second finger portion 320 that functions as a thumb may be individually operated.

Accordingly, according to one embodiment of the present invention, the robot hand 10 having the high degree of freedom may be further switched into tens of operation modes according to a situation in addition to the first to fourth operation modes illustrated in FIGS. 17 to 19.

As described above, according to one embodiment of the present invention, the robot hand 10 having the high degree of freedom may perform more precise or detailed movements, so that various hand signals may be formed, or, for example, various objects of different sizes or shapes may be gripped stably and efficiently.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

1. A robot hand having a high degree of freedom, the robot comprising:
a palm module having a set volume;
a first finger module including a first base frame detachably coupled to one side of the palm module, and at least two first finger portions connected to the first base frame in one direction and including a plurality of first segments;
a second finger module including a second base frame detachably coupled to an opposite side of the palm module, and a second finger portion connected to the base frame and including a plurality of second segments; and
a driving module mounted inside the palm module, and configured to operate the at least two first finger portions and the second finger portion,
wherein the driving module includes:
a wire driving portion configured to provide a driving force to wires that are individually connected to the first segments and the second segments, respectively; and
a gear driving portion configured to provide a driving force to gears that are individually connected to the at least two first finger portions and the second finger portion so as to enable abduction/adduction (A/A) operations of the at least two first finger portions and the second finger portion.

2. The robot of claim 1, wherein each of connection between the first finger portion and the first base frame and connection between the second finger portion and the second base frame is performed through a metacarpal (MCP) joint,
each of connection between the first segments adjacent to each other and connection between the second segments adjacent to each other is performed in a lengthwise direction through a proximal phalanx (PIP) joint and a distal phalanx (DIP) joint, and
the MCP joint provides 2 degrees of freedom, and each of the PIP joint and the DIP joint provides 1 degree of freedom.

3. The robot of claim 2, wherein the first segment includes a first-first segment connected to the first base frame through the MCP joint, a first-second segment connected to the first-first segment through the PIP joint, and a first-third segment connected to the first-second segment through the DIP joint, and
the first finger module further includes a first-first wire and a first-second wire connected to the first-first segment to bend/unfold the first-first segment about the MCP joint, a first-third wire and a first-fourth wire connected to the first-second segment to bend/unfold the first-second segment about the PIP joint, and a first-fifth wire and a first-sixth wire connected to the first-third segment to bend/unfold the first-third segment about the DIP joint.

4. The robot of claim 3, wherein the wire driving portion includes a first motor configured to provide a driving force to adjust tension of the first-first wire and the first-second wire, a second motor configured to provide a driving force to adjust tension of the first-third wire and the first-fourth wire, and a third motor configured to provide a driving force to adjust tension of the first-fifth wire and the first-sixth wire,
the first to third motors constitute one motor set connected to one of the first finger portions, and,
when a plurality of first finger portions are provided, the wire driving portion includes a plurality of motor sets that are in one-to-one correspondence with the first finger portions.

5. The robot of claim 4, wherein the first finger module further includes a first bearing array, and
the first bearing array is configured to provide movement paths of the first-first wire and the first-second wire from the first motor to the first-first segment, provide movement paths of the first-third wire and the first-fourth wire from the second motor to the first-second segment, and provide movement paths of the first-fifth wire and the first-sixth wire from the third motor to the first-third segment.

6. The robot of claim 5, wherein the first-first wire and the first-second wire are fixed to both widthwise sides of the first-first segment,
the first-third wire, the first-fourth wire, the first-fifth wire, and the first-sixth wire pass between the first-first wire and the first-second wire,
the first-third wire and the first-fourth wire are fixed to both widthwise sides of the first-second segment, and
the first-fifth wire and the first-sixth wire pass between the first-third wire and the first-fourth wire so as to be fixed to both widthwise sides of the first-third segment.

7. The robot of claim 4, wherein the first base frame includes a plurality of motor connection ports through which rotation shafts of the first to third motors are coupled, respectively,
each of the motor connection ports includes a stopper member configured to restrict a rotation range of each of the rotation shafts, and
the stopper member includes:
a rotation member axially coupled to the rotation shaft, and including a protrusion protruding in a radial direction on one circumferential side of the rotation member; and
a stopper facing both sides of a rotation path of the protrusion, and configured to restrain further rotation of the protrusion when the protrusion collides with the stopper while rotating.

8. The robot of claim 1, wherein the gear driving portion includes a fourth motor, and
the first base frame includes a bevel gear connected to the first finger portion and the fourth motor, and configured to transmit a driving force provided from the fourth motor to the first finger portion.

9. The robot of claim 2, wherein the second segment includes a second-first segment connected to the second base frame through the MCP joint, a second-second segment connected to the second-first segment through the PIP joint, and a second-third segment connected to the second-second segment through the DIP joint, and
the second finger module further includes a second-first wire and a second-second wire connected to the second-first segment to bend/unfold the second-first segment about the MCP joint, a second-third wire and a second-fourth wire connected to the second-second segment to bend/unfold the second-second segment about the PIP joint, and a second-fifth wire and a second-sixth wire connected to the second-third segment to bend/unfold the second-third segment about the DIP joint.

10. The robot of claim 9, wherein the wire driving portion includes a fifth motor configured to provide a driving force to adjust tension of the second-first wire and the second-second wire, a sixth motor configured to provide a driving force to adjust tension of the second-third wire and the second-fourth wire, and a seventh motor configured to provide a driving force to adjust tension of the second-fifth wire and the second-sixth wire.

11. The robot of claim 10, wherein the second finger module further includes a second bearing array, and
the second bearing array is configured to provide movement paths of the second-first wire and the second-second wire from the fifth motor to the second-first segment, provide movement paths of the second-third wire and the second-fourth wire from the sixth motor to the second-second segment, and provide movement paths of the second-fifth wire and the second-sixth wire from the seventh motor to the second-third segment.

12. The robot of claim 11, wherein the second-first wire and the second-second wire are fixed to both widthwise sides of the second-first segment,
the second-third wire, the second-fourth wire, the second-fifth wire, and the second-sixth wire pass between the second-first wire and the second-second wire,
the second-third wire and the second-fourth wire are fixed to both widthwise sides of the second-second segment, and
the second-fifth wire and the second-sixth wire pass between the second-third wire and the second-fourth wire so as to be fixed to both widthwise sides of the second-third segment.

13. The robot of claim 1, wherein the gear driving portion includes an eighth motor,
the second base frame includes a gear group connected to the second finger portion and the eighth motor, and configured to transmit a driving force provided from the eighth motor to the second finger portion, and
the gear group includes:
a first spur gear axially coupled to a rotation shaft of the eighth motor;
a second spur gear gear-coupled to the first spur gear;
a third spur gear axially coupled to an opposite lengthwise side of a shaft having one lengthwise side to which the second spur gear is axially coupled; and
a bevel gear having one side gear-coupled to the third spur gear and an opposite side connected to an end of the second finger portion.

14. The robot of claim 13, wherein the second finger portion is configured to perform the A/A operation in a path that reciprocates in a direction parallel to a palm surface provided as one side surface of the palm module and in a direction perpendicular to the palm surface.
